(19) United States
(12) Patent Application Publication
(10) Pub. No.: US 2011/0003116 A1
(43) Pub. Date: Jan. 6, 2011

(54) SARKING

(76) Inventors: Andreas Drechsler, Schaafheim (DE); Martino Cevales, Frankfurt (DE)

Correspondence Address: OSTROLENK FABER GERB & SOFFEN, 1180 AVENUE OF THE AMERICAS, NEW YORK, NY, 100368403, US

(21) Appl. No.: 12/745,794

(22) PCT Filed: Nov. 7, 2008
(86) PCT No.: PCT/EP2008/065183

§ 371 Date: Sep. 7, 2010

(30) Foreign Application Priority Data
Dec. 3, 2007 (DE) 10 2007 058 358.5

(51) Int. Cl. B32B 3/26; B32B 5/02; B32B 15/14; B32B 3/10

(52) U.S. Cl. 428/138; 428/319.1; 428/319.3; 442/376

(57) ABSTRACT

The invention relates to sarking which has a layer reflecting IR light. Said reflecting layer, which is a metal layer, is coated with a protective layer containing a plastic with added amorphous SiO₂ in order to prevent corrosion.

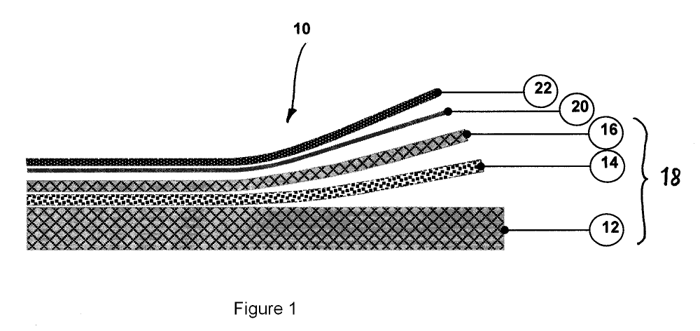

The invention relates to a sarking membrane [underlayment] according to the preamble of patent claim 1.

Underlayments are laminar building elements which, in particular in the case of pitched roofs, are disposed beneath water-draining roof coverings. They serve primarily for the downward drainage of driving snow or rain blown by the wind under the roofing. As a rule, counter battens or other spacers are provided above the underlayment.

Apart from mechanically repelling snow and rain, underlayments assume additional functions. The underlayments can be implemented such that they allow diffusion of water vapor, and via its [water vapor diffusion equivalent air-layer thickness] Sd value regulate the water vapor transport between the interior of the roof and the environment. A further additional function includes the reflection of heat or infrared radiation. Hereby is to be attained that the attic does not heat up too much in the summer and the heat losses are reduced in the winter.

A thermal reflective foil insulation for the field of construction, especially as a underlayment, is already disclosed in EP 1 311 387 B1. This thermal reflective foil insulation comprises a base polyethylene film with metallization layers vapor deposited on both sides. A protective varnish is applied over these metallization layers. Through this protective varnish the metallization layers are protected against corrosion. As the protective varnish is utilized a two-component varnish based on polyurethane cured with isocyanate.

There is furthermore disclosed (EP 1 184 482 B1) a method for the production of a water vapor permeable, water-tight and thermal reflective sheet composite. This composite comprises a continuous metal layer and a pore-free, water vapor permeable and water-tight hydrophilic synthetic film. The film is herein first precleaned by plasma treatment in oxygen or in an oxygen-containing gas. A metal layer is subsequently applied at a thickness of 10 to 200 nm, onto which a protective layer based on a cross-linked polyurethane is applied.

Known are further pastes containing a matting agent and/or structuring additives which include 5 to 30 wt % of one or more (meth)acrylate copolymers and/or one or more polyesters, 15 to 45 wt % of one or more matting and/or structuring agents as well as 30 to 65 wt % of one or more organic solvents (DE 199 17 228 B4). Cross-linking and dispersing agents, rheological agents, catalysts and optionally further additives and auxiliaries can be added. The (meth)acrylate resins and polyester resins can be thixotroped through the addition of conventional thixotroping agents.

There is further known a composition curable with visible light, which comprises 2 to 99 wt % of a compound [containing] acrylate and/or methacrylate groups and/or vinyl- and/or epoxide and/or oxetane groups and/or acryl-epoxy-oligomer groups and or one resin compound based on polymerizable polysiloxanes (DE 199 50 284 A1). The composition comprises further at least one initiator, at last one co-initiator as well as one or more modifiers, such as fillers, dyes, pigments, flow improvers, thixotroping agents, polymeric thickeners, oxidizing additives, stabilizers and retardants.

A composite metallized foil is furthermore known, which comprises a water vapor permeable layer with first and second surfaces, wherein this layer has at least one woven or non-woven structure (US 2006/0040091 A1). On the first surface is applied a metal layer having a thickness of approximately 15 to 200 nanometer, wherein, on this metal layer, in turn, an organic coating is applied from the group of organic polymers, organic oligomers or a combination of both. This organic coating, which has the function of a protective varnish layer, has a thickness of 0.2 μm to 2.5 μm. However, it was found that a protective varnish layer of such thickness does not ensure permanent corrosion protection in reflective layers with woven structure.

The invention therefore addresses the problem of providing a thermal reflective underlayment permitting the diffusion of water vapor, in which a permanent protection of the reflective layer is ensured and which, nevertheless, has good water vapor permeability.

This problem is resolved through the features of patent claim 1.

The invention thus relates to an underlayment which includes an infrared light reflecting layer. To avoid corrosion, this reflecting layer, which is a metal layer, is coated with a protective layer containing a synthetic with an addition of amorphous SiO₂.

In the simplest case the underlayment is composed of three layers, namely of at least one layer permitting diffusion of water vapor, a thermal reflecting metal layer and a protective layer applied onto the metal layer. The water vapor diffusion layer can herein be a spunbonded fabric, a woven fabric or a film of organic polymeric material. Due to their structure, spunbonded fabrics are woven fabrics permit the diffusion of water vapor, while the films must be implemented such that they are microperforated or microporous in order to permit water vapor diffusion. The thermal reflecting metal layer is preferably vapor deposited in vacuo onto the water vapor diffusion layer. On the water vapor diffusion layer, however, no continuous metal layer is generated since the latter in a spunbonded fabric is discontinuous due to the relatively large pores and, in a film it is discontinuous in the proximity of the micropores or microholes. As the metal preferably pure aluminum or an aluminum alloy is utilized. To avoid corrosion, the metal layer is coated with a protective layer which contains a synthetic material with an addition of amorphous SiO₂.

A conventional protective varnish applied onto a water vapor diffusion layer considerably reduces its water vapor permeability. This effect is significantly reduced in the invention thereby that amorphous SiO₂ is added to the protective layer. The thus modified protective layer permanently protects the metal layer against corrosion and mechanical abrasion and yet ensures that the high water vapor permeability of the water vapor diffusion layer is retained. The reasons for these effects are possibly that, for example, an acrylate dispersion modified with amorphous SiO₂ has an increased flowability compared to a pure acrylate dispersion. For example, if the metal layer is applied onto a water vapor diffusion layer with bonded structure and subsequently coated with a modified acrylate dispersion, this [modified acrylate dispersion] flows into the pores of the metallized bonded fabric and wets the filaments, e.g., the endless chemical fibers. Due to its low flowability, a pure acrylate dispersion penetrates less well into the pores and also encompasses the filaments less well. Rather, the pure acrylate dispersion tends to clog the pores which makes water vapor diffusion difficult.

An embodiment example is depicted in the sole FIGURE and will be described in the following.

The FIGURE shows an underlayment 10 according to the invention with multi-layer structure. The underlayment 10 comprises here a first spunbonded fabric layer 12 which has, for example, a mass per unit area of 120 g/m² and is produced of polypropylene. On the first spunbonded fabric layer 12 is located a film 14 of polypropylene, which can be implemented to be microporous or microperforated. Due to the microperforation or the micropores, this film 14 permits water vapor diffusion is, however, air-draft tight. On the film 14, which is comprised, for example, of polypropylene with a mass per unit are of 30 g/m², is applied a second spunbonded fabric layer 16, which is produced, for example, of polypropylene and has a mass per unit area of 20 g/m². Due to their structure, the two spunbonded fabric layers 12, 16 are implemented such that they permit the diffusion of water vapor. From the first spunbonded fabric layer 12, the film 14 and the second spunbonded fabric layer 16 a composite 18 is produced using the thermal bonding method. Onto the second spunbonded fabric layer 16 of the composite 18 a metal layer 20, preferably of aluminum, is applied under high vacuum. This application can take place by vapor deposition or sputtering. As a corrosion protection, a protective layer 22 is applied onto the metal layer 20, which protective layer comprises amorphous SiO₂. An example of amorphous SiO₂ is quartz glass. In the embodiment example described in the FIGURE, the water vapor diffusion layer provided with metal layer 20 is formed by the second spunbonded fabric layer 16. The water vapor diffusion layer can alternatively be formed by film 14. The protective layer 22 is in this case applied onto film 14.

The above described composite represents only one embodiment of several conceivable embodiments. Simpler structural systems are also conceivable, in which the discrete layers are not thermal bonded but rather are adhered to one another. Single-layer bonded fabrics permit diffusion, however, they are not wind-tight. A two-layer composite of microporous foil and bonded fabric, in contrast, is wind-proof and permits diffusion. However, as a rule, a microporous layer is not sealed against UV light and mechanical loading. A three-layer structure, in contrast, has good values at UV resistance, is mechanically robust and, moreover, is wind-tight. Each of the layers can have a different weight.

For the documentation of the described effects, comparison tests were carried out, whose results are compiled in the following Table (PP=polypropylene).

| | | | Protective | | | | Suitability |
|---|---|---|---|---|---|---|---|
| | | | Varnish | Weight of | | | Corrosion |
| | | Protective | SiO₂ Content | Layer | Corrosion | Sd Value | Protection and Sd |
| Test | Composite | Varnish | % | g/m² | Protection | m | value |
| I | 120 g/m² PP | — | — | — | — | 0.04 | — |
| | spunbonded fabric | | | | | | |
| | 28 g/m² PP | | | | | | |
| | microporous | | | | | | |
| | 20 g/m² PP | | | | | | |
| | spundbonded fabric | | | | | | |
| II | 120 g/m² PP | Acrylate | 0 | 8.6 | Fails | 0.10 | Not good due to |
| | spunbonded fabric | | | | | | corrosion |
| III | 28 g/m² PP | | 0 | 11.2 | Good | 0.15 | Not good due to |
| | microporous | | | | | | Sd value |
| IV | 20 g/m² PP | | 0 | 13.3 | Good | 0.15 | Not good due to |
| | spunbonded fabric | | | | | | Sd value |
| V | 35 nm Al | Acrylate | 45% | 8 | Good | 0.06 | Good |
| VI | | with | 45% | 10 | Very | 0.07 | Very good |
| | | amorphous | | | good | | |
| VII | | SiO₂ | 60% | 11.2 | Very | 0.05 | Very good |
| | | | | | good | | |

In the comparison tests the corrosion resistance was tested and the Sd value describing the water vapor permeability was determined. To effect corrosion, the samples were held for 15 minutes above boiling water. Hereby corrosion results are obtained which normally occur within three months at a relative air humidity of 100% and 60° C. Subsequently the extent of corrosion was optically examined and assessed. The Sd values were measured in accordance with EN-DIN 12572.

As is evident in the above Table, Test I shows the vapor permeability of composite 18 which is comprised of the first spunbonded fabric layer 12 (120 g/m² polypropylene), film 14 (28 g/m² microporous film of polypropylene) and the second spunbonded fabric layer 16 (20 g/m² polypropylene). Since this composite 18 defines the water vapor permeability of the underlayment 10, in Test I a reference measurement of the Sd value was carried without application of the metal layer 20 and of the protective layer 22. The Sd value for these three layers 12, 14, 16 is 4 cm.

In Tests II to VII the underlayment 10 according to Test I was additionally equipped with a metal layer 20, which was comprised of a 35 nm thick aluminum layer and was each coated with different protective layers 22. In Tests II to IV onto the underlayment 10 a pure acrylate dispersion was applied as the protective layer 22. In Tests V to VII, in contrast, the protective layer 22 was comprised of an acrylate dispersion which in Tests V and VI was mixed with 45% and in Test VII with 60% SiO₂. The percentages with respect to the addition of amorphous SiO₂ refer herein to the weight of the dried protective layer 22. The tests have demonstrated that the underlayment 10 with a protective varnish 22 modified with amorphous SiO₂ had the best properties regarding corrosion protection and Sd value.

With respect to the limits of addition of amorphous SiO₂ the following should be observed. Through a minimal addition of amorphous SiO₂ the properties of the protective layer 22 approach those of a pure acrylate dispersion. To attain an appreciable effect, addition of at least 10% SiO₂ is necessary. Above 60% it becomes increasingly more difficult to obtain a clear film-like protective layer 22 on the metal layer 20, which leads to rapid reduction of the reflective capability of the underlayment 10. The addition of amorphous SiO₂ in practice has an upper limit at which the reflective capability falls below the minimum value required for a thermal reflecting underlayment. The minimum value for the reflective capability of the underlayment 10 conventionally lies at 50%.

### EXAMPLE 1

First, a three-layer composite 18 of a first polypropylene spunbonded fabric layer 12 with a weight of 120 g/m², a microporous polypropylene film 14 with a weight of 30 g/m² and a second polypropylene spunbonded fabric layer 16 with a mass per unit area of 20 g/m² was produced by thermal bonding. Onto the second polypropylene spunbonded fabric diffusion layer 16 of the composite 18 under high vacuum a metal layer 20 of aluminum was vapor deposited. This metal layer had a thickness of 35 to 50 nm.

The top side of the second polypropylene spunbonded fabric layer 16 provided with the metal layer 20 was subsequently coated with 12 g of a varnish (5 g solid) forming the protective layer 22, which varnish was comprised of 70 parts by weight of an aqueous pure acrylate dispersion (48% solid, Tg=15° C.) and 30 parts by weight of an aqueous silica sol (30% solid, 300 m²/g surface). The coating was applied by airless spraying and dried in a continuous drier. The dried varnish of the protective layer 22 had a fraction of 21% of amorphous SiO₂.

### EXAMPLE 2

First, a three-layer composite 18 of a first polypropylene spunbonded fabric layer 12 was produced by thermal bonding with a weight of 120 g/m², a microperforated polypropylene film 14 with a weight of 30 g/m², and a second polypropylene spunbonded fabric layer 16 with a mass per unit area of 20 g/m². Onto the second polypropylene spunbonded fabric diffusion layer 16 of the composite 18 a metal layer 20 of aluminum was vapor deposited under high vacuum, which layer had a thickness of 60 nm.

The top side of the second polypropylene spunbonded fabric layer 16 provided with the metal layer 20 was subsequently coated with 27 g of a varnish (10 g solid) forming the protective layer 22. The varnish was comprised of 40 parts by weight of an aqueous pure acrylate dispersion (48% solid, Tg=15° C.) and 60 parts by weight of an aqueous silica sol (30% solid, 300 m²/g surface). The protective layer 22 was applied using a calender, e.g., a rolling machine with rollers disposed one above the other and rotating in opposite directions, and dried in a continuous drier. The dried varnish of the protective layer 22 had a fraction of 48% of amorphous SiO₂. The particle size of the amorphous SiO₂ can herein be 1000 nm.

The above listed materials are only examples. Layers 12, 14, 16 are exclusively comprised of polypropylene since hereby the thermal bonding can be carried out in simple manner. The described process, in which a prefabricated composite was metallized and coated, serves also only as an example. It would also be feasible to metallize the outer layer of the composite first, and subsequently connect it with the other layer and apply the coating at the end. It would also be feasible to metallize the outer layer first and to varnish it and only hereupon to connect it with the other layers.

As a rule, metal layers do not permit diffusion. However, in the invention [onto] a fabric that is not closed [a layer] is vapor deposited, which does not have a closed surface. Since [onto] the foil subjacent to the fabric [a layer] is not vapor deposited, small holes remain in the metal foil. It is also feasible to provide the foil with holes after the metal has been vapor deposited. Instead of the listed acrylic resin, polymers of polyurethane can also be utilized as bonding agents.

The listed Sd values are specified for materials Sd>0.2 m in EN ISO 1931 and in EN ISO 12572 for materials with Sd<0.2 m. In DIN 4802.3 can also be found references to Sd values.

These values were defined due to the effect that from the, as a rule, higher room temperature to lower outside temperatures a vapor pressure gradient forms which tends to become equalized through diffusion. This natural diffusion is slowed by coatings or barrier foils. The resistance to this equalization is described by the water vapor diffusion flow density or the Sd value. The Sd value or the diffusion equivalent air layer thickness indicates the length of time water vapor requires for its migration through an air-tight structural part. If the value is, for example, 3 m, this indicates that the water vapor in the convection through the air-tight plane requires the same length of time as for the migration through a 3 m thick air layer. Thus, the resistance of the structural part to the water vapor is as large as it is in a 3 m thick air layer.

1. Underlayment with at least one layer permitting water vapor diffusion, a metal layer on the water vapor diffusion layer and a protective layer on the metal layer, characterized in that the protective layer comprises amorphous SiO₂.

2. Underlayment as claimed in claim 1, characterized in that the protective layer comprises acrylate polymers.

3. Underlayment as claimed in claim 1, characterized in that the amorphous SiO₂ has a fraction of 10% to 50% of the weight of the dried protective layer.

4. Underlayment as claimed in claim 1, characterized in that the particle sizes of the amorphous SiO₂ are smaller than 1000 nm.

5. Underlayment as claimed in claim 1, characterized in that the fraction of amorphous SiO₂ is maximally 60% of the weight of the dried protective layer.

6. Underlayment as claimed in claim 1, characterized in that the protective layer comprises pure acrylate.

7. Underlayment as claimed in claim 1, characterized in that the protective layer has a mass per unit area of 5 to 20 g/m².

8. Underlayment as claimed in claim 1, characterized in that the thickness of the protective layer is between 5000 and 15000 nm.

9. Underlayment as claimed in claim 1, characterized in that the water vapor diffusion layer is a spunbonded fabric layer and/or a film.

10. Underlayment as claimed in claim 9, characterized in that on the spunbonded fabric layer a film is provided.

11. Underlayment as claimed in claim 10, characterized in that on the film a second spunbonded fabric layer is provided.

12. Underlayment as claimed in claim 11, characterized in that on the second spunbonded fabric layer a metal layer is provided.

13. Underlayment as claimed in claim 10, characterized in that on the film a metal layer is provided.

14. Underlayment as claimed in claim 9, characterized in that the film is implemented such that it is microperforated or microporous.

15. Underlayment as claimed in claim 2, characterized in that the amorphous SiO₂ has a fraction of 10% to 50% of the weight of the dried protective layer.

16. Underlayment as claimed in claim 2, characterized in that the fraction of amorphous SiO₂ is maximally 60% of the weight of the dried protective layer.
